(19) United States
(12) Patent Application Publication
(10) Pub. No.: US 2025/0138496 A1
(43) Pub. Date: May 1, 2025

(54) REMOTE ADMINISTRATION OF HOT RECEPTACLES

(71) Applicant: Burton M. Smith, III, Panama City Beach, FL (US)

(72) Inventor: Burton M. Smith, III, Panama City Beach, FL (US)

(21) Appl. No.: 18/493,966

(22) Filed: Oct. 25, 2023

(51) Int. Cl. G05B 15/02; H01R 13/66

(52) U.S. Cl. CPC G05B 15/02; H01R 13/6691

(57) ABSTRACT

Methods, systems, and products are provided for remote administration of hot receptacles according to embodiments of the present invention. Embodiments include receiving, by a slave unit from a master unit, a signal containing an on-off value in dependence upon whether power is currently being delivered to the master from a switched-controlled receptacle and delivering power, by the slave to slave-serviced appliances in dependence upon the on-off value.

### BACKGROUND

Modern buildings are wired with electrical outlets usefully placed throughout the structure. Electrical outlets may have one or more receptacles that are switch controlled or hot. In some cases, an outlet may be half-switched having one receptacle that is switch controlled and another that is hot. In such cases, an electrical appliance may be plugged into a switch-controlled receptacle and left powered on such that the switch may be used to control powering on and off the appliance. The same device plugged into an outlet of only hot receptacles will have to be powered on and off at the appliance itself or through the use of a device-specific remote control. This may make some appliances less convenient in locations near outlets with only hot receptacles. It would be advantageous to remotely control the power from always-hot receptacles.

### BRIEF DESCRIPTION OF THE DRAWINGS

FIG. 1 sets forth a line drawing of a floor plan of a living room of house implementing remote control of hot receptacles according to embodiments of the present invention.

FIG. 2 sets forth a flow chart illustrating an example method of providing remote control for an always-hot receptacle in dependence upon the state of a switch-powered receptacle according to embodiments of the present invention.

FIG. 3 sets forth a line drawing of a system for remote administration of hot receptacles according to embodiments of the present invention.

FIG. 4 sets forth a schematic diagram of aspects of a slave unit according to embodiments of the present invention.

FIG. 5 sets forth a schematic diagram of aspects of a master unit according to embodiments of the present invention.

FIG. 6 sets forth an example a sequence diagram of an example method of providing remote control for an always-hot receptacle through a switch for a switched receptacle.

### DETAILED DESCRIPTION OF EXAMPLE EMBODIMENTS

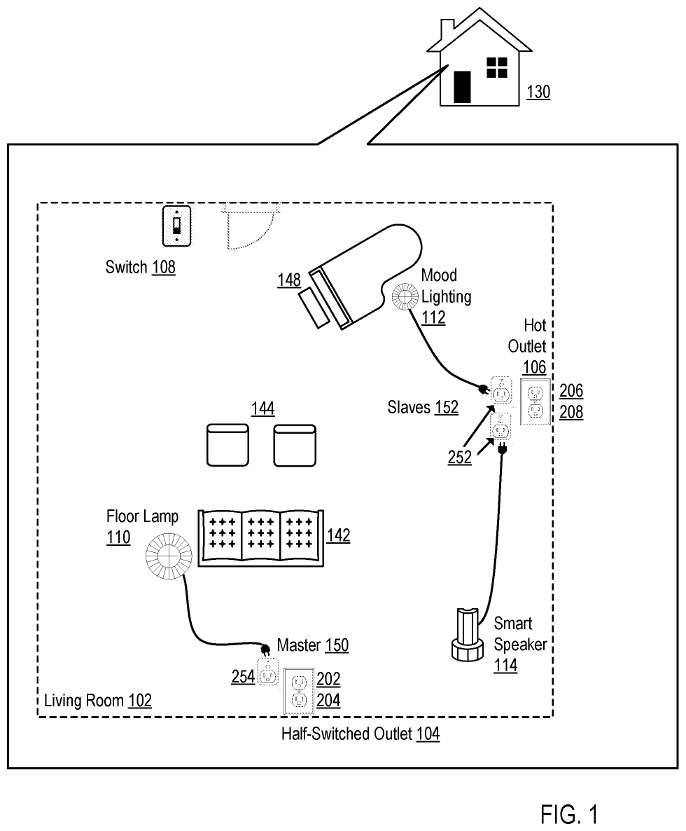

Methods, systems, devices, and products for remote administration of hot receptacles are described with reference to the attached drawings beginning with FIG. 1. FIG. 1 sets forth a line drawing of a floor plan of a living room of house implementing remote control of hot receptacles according to embodiments of the present invention. The living room of FIG. 1 includes a sofa (142) and accompanying chairs (144) positioned in a seating arrangement with a floor lamp (110). The living room also includes a piano (148) with adjacent mood lighting (112) and a smart speaker (114).

The living room (102) of FIG. 1 includes a half-switched outlet (104) and an outlet (106) having only hot receptacles (206, 208). The half-switched outlet (106) includes one hot receptacle and one switched receptacle controlled by the switch (108). In this disclosure, the term “outlet” is used to describe the location or enclosure that includes one or more power jacks called “receptacles.”

The floor lamp (110), mood lighting (112), and a smart speaker (114) are appliances adapted to be powered by being plugged into a receptacle of a wall outlet. The mood lighting (112) and the smart speaker (114) are located such that power is delivered to these appliances by a hot outlet (106) with two always-hot receptacles (206 and 208). Those of skill in the art will immediately recognize that absent the system of the present invention, power to the mood lighting (112) and the smart speaker (114) must be actuated at the device itself or through some other device-specific remote control.

In the example of FIG. 1, the floor lamp (110) is located such that power is delivered by a half-switched outlet (104) having one switched receptacle (204) and one hot receptacle (202). The system of FIG. 1 therefore includes a master unit (150) adapted for a switched receptacle (202) and one or more slave units (152) adapted for an always-hot receptacle (206 and 208) according to embodiments of the present invention. The floor lamp (110) is plugged into the socket (254) of the master (150) which in turn is plugged into the switched receptacle (204).

The master (150) and the slave (152) of FIG. 1 include a socket (254, 252) adapted to receive a power plug of an electrical appliance, in this example a floor lamp (110), and to provide power to that device from the receptacle into which the master or slave is inserted. In this example, the floor lamp (110) is plugged into the master which in turn is plugged into the switched receptacle (204). To more clearly delineate the terms used in present disclosure, the term socket (254) is used to describe the power jacks exposed by the master and slave adapted to accommodate a plug of an electrical appliances being serviced. The term receptacle is used to describe the power jacks of the outlet into which the master and slave are plugged.

Both the master (150) and the slave (152) are adapted to reside between the appliance they service and the receptacle of an outlet into which they are inserted and deliver power to the appliance they service in accordance with embodiments of the present invention. The master unit (150) is adapted to deliver power to an electrical appliance upon the receiving power from the switched receptacle into which the master is inserted. That is, when the switch (108) switches-on power to the switched receptacle (202), power is delivered to the appliance (110) serviced by the master (150).

The slave unit (152) is also adapted to provide power to an electrical appliance. However, the slave unit (152) is adapted to provide power to the serviced electrical appliance only when power is being delivered to the switched receptacle of the master. In this way, appliances serviced by the slave (152) are powered on and off by the switch (108) controlling the receptacle of the master and as such are powered on and off together with the appliances serviced by the master.

In the example of FIG. 1, power to the mood lighting (112) and the smart speaker (114) by the slaves (152) is controlled by the state of power being delivered to the master (150) which is in turn controlled by the switch (108). A user is advantageously empowered to turn on and off all the outlet-powered appliances of FIG. 1 with a single switch without having to adjust or rewire the infrastructure of the room or maintain three device-specific remote controls.

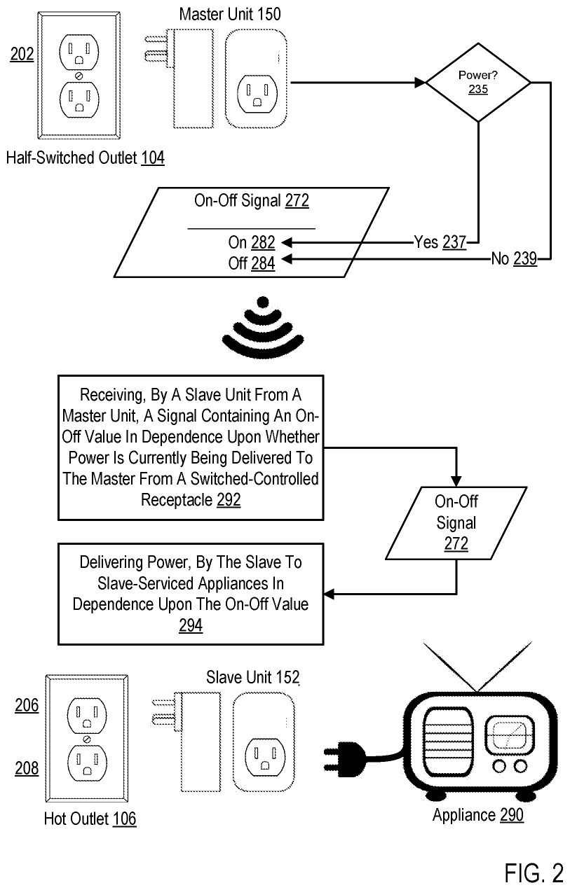

For further explanation, FIG. 2 sets forth a flow chart illustrating an example method of providing remote control for an always-hot receptacle in dependence upon the state of a switch-powered receptacle according to embodiments of the present invention. The example of FIG. 2 includes a master unit (150) and a slave unit (152) each adapted to deliver power to an appliance from a receptacle of an outlet according to embodiments of the present invention. The method of FIG. 2 includes receiving (292), by a slave unit (152) from a master unit (150), a signal (272) containing an on-off value (282 and 284) in dependence upon whether power is (237) or is not (237) currently being delivered (235) to the master (150) from a switched-controlled receptacle (202).

The method of FIG. 2 includes delivering (294) power, by the slave (152) to slave-serviced appliance (290) in dependence upon the on-off value (282 and 284). In the example of FIG. 2, the on-off signal (272) is a digitally encoded signal broadcast from the master to one or more slaves. The on-off signal (272) is typically implemented as a radio frequency digitally encoded signal having a packet structure that includes a header including the device ID of the master and optionally device IDs of one or more slaves, information useful in communication between master and slaves, and also optionally information used for pairing master and slaves.

The packet structure of the on-off signal (272) includes a payload containing a value representing the state of power delivery to the master-on (282) or off (284). Those of skill in the art will recognize that multiple slaves may co-exist in proximity without interfering with each other or other devices. The encoding makes the devices which use unlicensed FFC dedicated frequency for such devices, in this case 433 Mhz, impervious to spurious signals or noise on that frequency.

In typical embodiments of the present invention, a master and slave must be paired for communications. In some embodiments, the master and slave are paired during manufacture and require no pairing prior to operation or are paired using static dipswitches. In other embodiments, the pairing may occur through the use of pairing modules in the master (150) and slave (152) that implement a pairing protocol upon invoking pairing functions on the master or slave.

A two-way pairing protocol is expensive and cumbersome; as is user intervention. As such, in some embodiments a one-way pairing algorithm may be initiated upon power delivery to the master the first time a master is plugged into an activated outlet or upon invocation of a button or other mechanism. In such embodiments, slaves listen for pairing signals containing pairing information, on-off values and other information such that pairing occurs without user intervention with a one-way protocol.

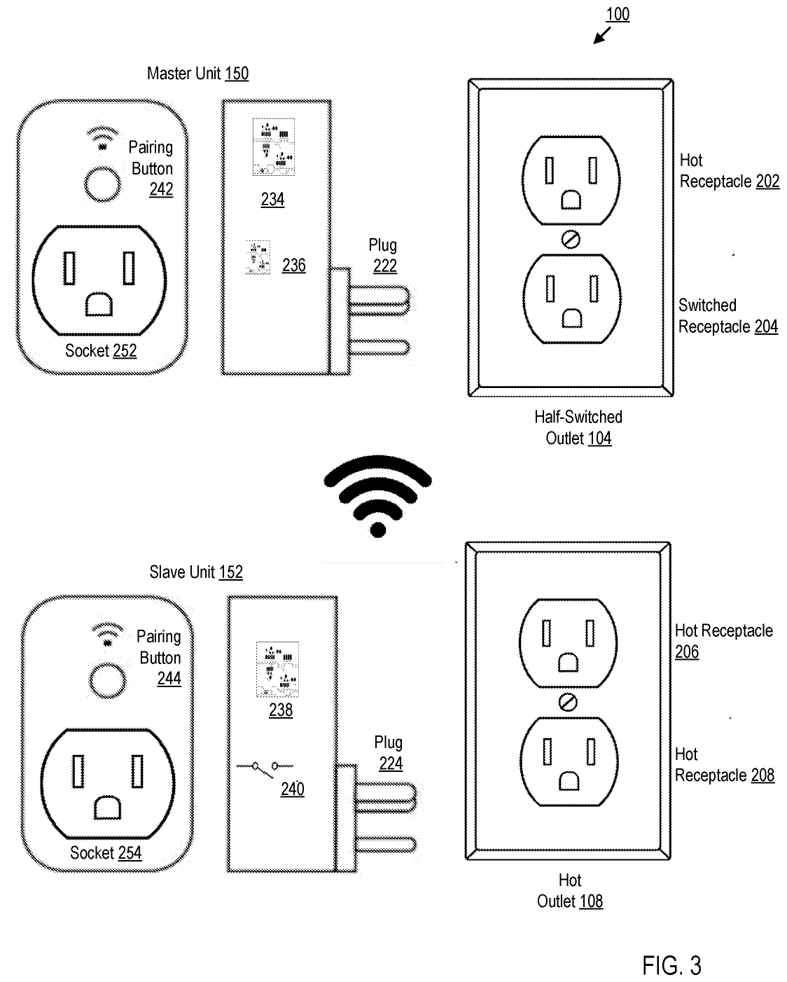

For further explanation, FIG. 3 sets forth a line drawing of a system (100) for remote administration of hot receptacles. The system of FIG. 3 includes a master unit (150) adapted for a switched receptacle (104) and a slave unit (152) adapted for a hot receptacle. The master unit (150) and slave unit (152) include a socket (252) in electrical communication with an electrical plug (222). As mentioned above, the term “outlet” is used to describe the location or enclosure that includes one or more power jacks called “receptacles.” For clarity, the power jacks exposed by the master (150) and slave (152) are called “sockets” in this disclosure. Sockets according to embodiments of the present invention are adapted to deliver power to electrical appliances as will occur to those of skill in the art.

The master unit (150) of FIG. 3 includes a radio-frequency transmitter (234) configured to send an on signal in dependence upon current being received through the electrical plug (222) to the socket and configured to broadcast an off signal in dependence upon the cessation of current received through the electrical plug (222).

The master unit (150) of FIG. 3 also includes a passive power-down logic (236) charged when current is received through the electrical plug. Passive power-down logic (236) advantageously allows a master to be powered only through the receptacle into which it is plugged without requiring a device. In such embodiments, upon receiving power from the switched receptacle (204) the master is powered on and empowered to broadcast signals to the slaves. Upon termination of that power, the passive-power down logic provides enough current remaining in the master to support the radio-frequency transmitters broadcast one or more off-signals informing the slaves that the switch-controlled receptacle is off and instructing them to cease powering the appliances they are servicing. Advantageously, the passive power-down logic does not require a replaceable or rechargeable battery.

The system of FIG. 3 includes a slave unit (152) adapted for an always-hot receptacle (108). The slave (152) includes a socket (254) in electrical communication with an electrical plug (224). The slave (152) of FIG. 3 includes a radio-frequency receiver (238) configured to listen for an on signal or an off signal. The slave (152) of FIG. 3 includes a switch (240) configured to allow current to flow between the electrical plug (204) to the socket (254) dependence upon the receiving an on signal and to prevent current from flowing in dependence upon receiving an off signal.

The master unit (150) and slave unit (152) each have a pairing module configured to pair the master unit and slave unit for radio frequency communications. In the example of FIG. 2, the master and slave expose a pairing button (242 and 244) for user-initiated pairing of the master and the slave.

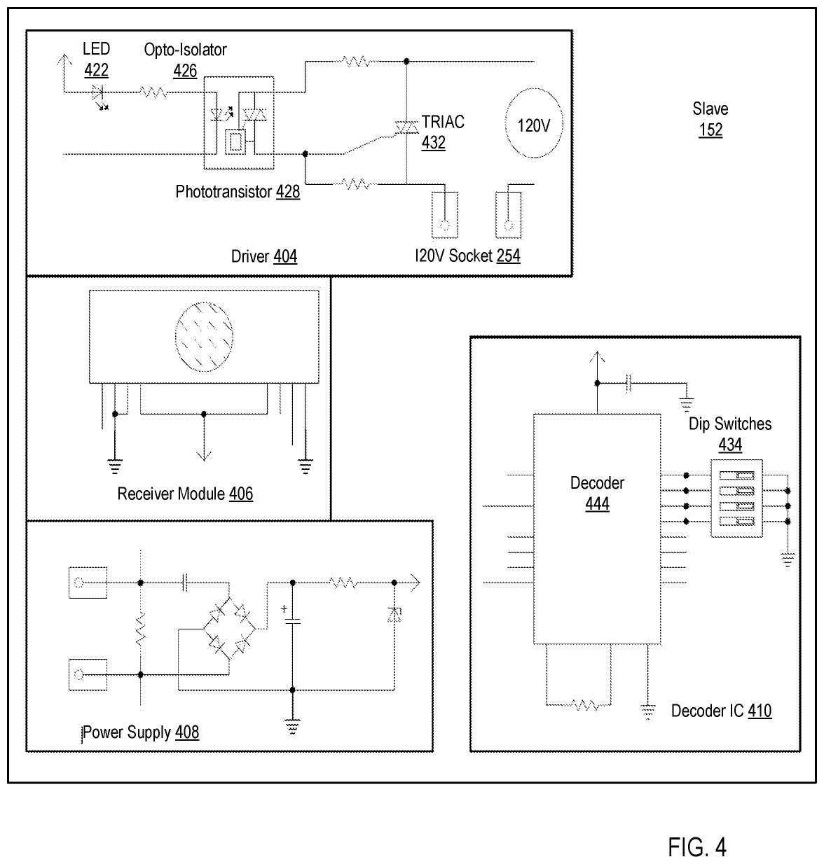

For further explanation, FIG. 4 sets forth a schematic diagram of aspects of a slave unit according to embodiments of the present invention. The slave (152) includes a driver (404), a receiver module (406), and a decoder integrated circuit (410). The driver (404) of FIG. 4 includes an opto-isolator (426). An opto-isolator, sometimes called an optocoupler, photocoupler, or optical isolator, is an electronic component that transfers electrical signals between two isolated circuits by using light. A common type of opto-isolator consists of an LED (422) and a phototransistor (428) in the same opaque package. Other types of source-sensor combinations include LED-photodiode, LED-LASCR, and lamp-photoresistor pairs. Usually opto-isolators transfer digital (on-off) signals, but some techniques allow them to be used with analog signals.

The driver (404) of FIG. 4 also includes a TRIAC (432), a three-terminal electronic component that conducts current in either direction when triggered. The bidirectionality of TRIACs makes them useful switches for alternating current. The driver (404) of FIG. 4 includes a socket (254) for delivering power to serviced appliances. One example TRIAC that may be usefully employed in remote administration of hot receptacles according to embodiments of the present invention is the NXT BT 138 Triac.

The slave (152) of FIG. 4 includes a receiver module (406). One example receiver module that may be usefully employed in remote administration of hot receptacles according to embodiments of the present invention is a Wenshing RWS-371 RF wireless receiver. The slave (152) also includes a power supply (408) adapted to receive power from a hot receptacle such that a serviced appliance may be powered.

The slave (152) of FIG. 4 includes a decoder integrated circuit (410) including a decoder (444) and a set of dip switches (434). One example receiver module that may be usefully employed in remote administration of hot receptacles according to embodiments of the present invention is a HT12D IC from WELLPCB. The decoder (444) operates alongside an encoder (like HT12E) through matched address bits set in this case with the configuration of the dip switches (434).

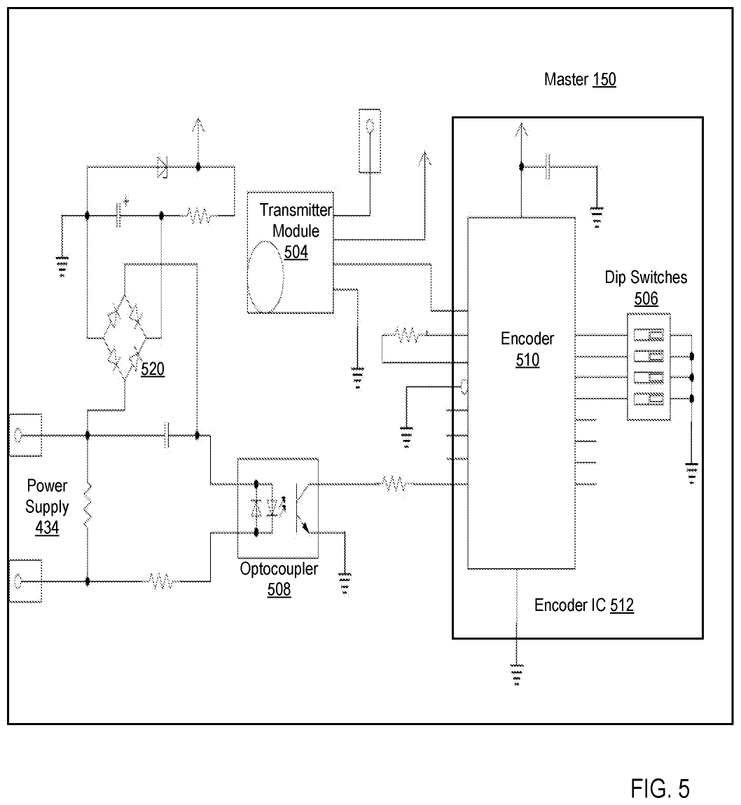

For further explanation, FIG. 5 sets forth a schematic diagram of aspects of a master unit according to embodiments of the present invention. The example master (150) of FIG. 5 includes a transmitter module (504), an optocoupler (508), and an encoder IC (512). The transmitter module (504). One transmitter module that may be usefully employed in remote administration of hot receptacles according to embodiments of the present invention is a Wenshing TWS-BS RF wireless transmitter.

The master (150) of FIG. 4 includes an encoder integrated circuit (410) including an encoder (510) and a set of dip switches (506). One example encoder IC that may be usefully employed in remote administration of hot receptacles according to embodiments of the present invention is a WELLPCB HT12E IC. The encoder operates alongside an encoder (like HT12D) through matched address bits set in this case with the configuration of the dip switches (506). The slave (152) also includes a power supply (408) adapted to receive power from a hot receptacle such that a serviced appliance may be powered.

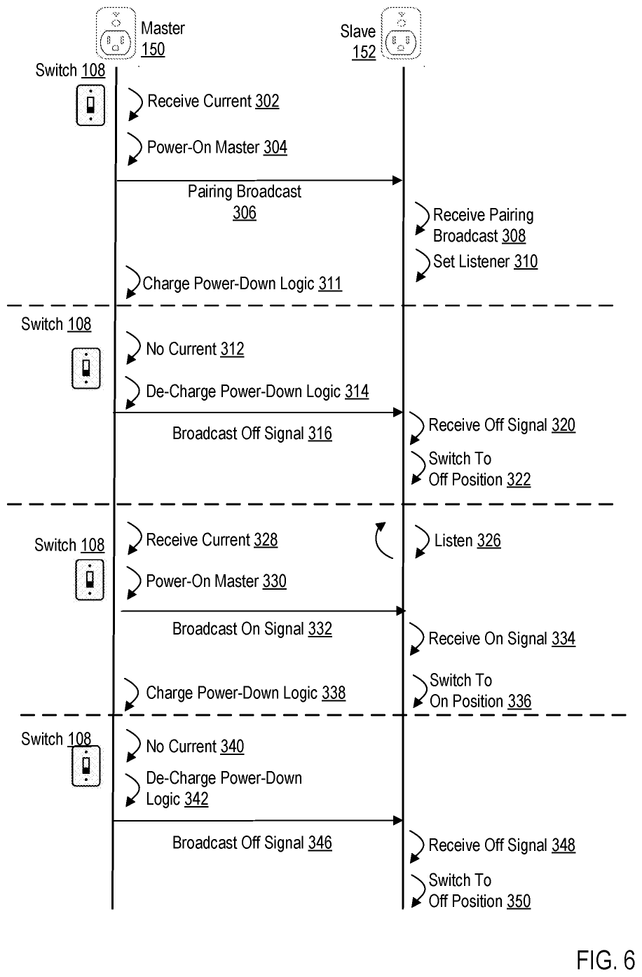

For further explanation, FIG. 6 sets forth an example a sequence diagram of an example method of providing remote control for an always-hot receptacle through a switch for a switched receptacle. Upon actuation of the switch (108), the master (150) receives current (302) and powers-on (304). The example of FIG. 6 includes broadcasting (306), by the master (150), a pairing signal. Upon receiving the pairing signal (308), the slave sets a listener (310) to listen for control signals from the master (150). Once paired, appliances plugged into the slave will be delivered current from the always hot receptacle in dependence upon a switch position controlling the master (150).

The method of FIG. 6 includes charging (311), by the master unit (150), power-down logic with the received current. Charging the power-down logic allows the master unit to operate without any internal battery and sustains enough charge to power the broadcast of one or more off signals prior to completely powering off.

Upon switching the switch (108) to the off position, the master (150) no longer receives current (312). The method of FIG. 6 includes de-charging (314), by the master (150), the passive power-down logic and broadcasting (316) an off signal.

The method of FIG. 6 continues by receiving (320), by the slave, the off signal and switching (322), by the slave (152), a switch to an off position preventing current from passing through the slave to any applicant plugged into the slave.

While the master is now powered off, the slave is still powered by the always hot receptacle into which the slave is plugged. As such, in some embodiments the slave continues listening (326), by a slave (152), for an on signal or an off signal.

The example of FIG. 6 describes a one-way pairing protocol that requires no user intervention. In the example of FIG. 6, once paired, the master may be switched on and off without requirement to re-pair the master and the slave. In other embodiments, such pairing may occur every time power is first received by the master. In those embodiments, the pairing signal and the one signal may be the same value, sent together, or otherwise comingled as will occur to those of skill in the art.

In the method of FIG. 6, sometime later, upon actuation of the switch (108), the master (150) again receives current (328) and powers-on (320). The example of FIG. 6 includes broadcasting (322), by the master (150), an on signal.

The method of FIG. 6, receiving (334) the on signal and switching (336), by the slave (152), a switch to the on position allowing current to pass through the slave to any applicant plugged into the slave.

The method of FIG. 6 includes charging (338), by the master unit (150), power-down logic with the received current. Charging the power-down logic allows the master unit to operate without any internal battery and sustains enough charge to power the broadcast of one or more off signals prior to completely powering off.

When the switch (108) is returned to the off position causing current to no longer be delivered to the master and upon no longer receiving current (338), the method of FIG. 6 includes de-charging (342), by the master (150), the passive power-down logic and broadcasting (346), by a radio-frequency transmitter of the master (150), an off signal.

The method of FIG. 6 includes receiving (348) the off signal and switching (350), by the slave (152), the switch (240) to the off position.

In the example of FIG. 6, the on signal and the off signal are depicted as being broadcast only once upon actuation of the switch. This is for ease of explanation and not for limitation. In many embodiments, a master unit receiving current from a hot receptacle will periodically send on signals so long as current is being received. Similarly, upon powering down, the master may send off signals iteratively until the master completely powers down.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A system for remote administration of an always-hot receptacle of an electrical outlet,
the system comprising:
a master unit adapted for a switched receptacle comprising:
a socket in electrical communication with an electrical plug;
a radio-frequency transmitter configured to send an on signal in dependence upon current being received through the electrical plug to the socket and configured to broadcast an off signal in dependence upon the cessation of current received through the electrical plug; and
a passive power-down logic charged when current is received through the electrical plug and providing current to the radio frequency transmitter upon cessation of current received through the electrical plug.
and;
a slave unit adapted for an always-hot receptacle comprising:
a socket in electrical communication with an electrical plug;
a radio-frequency receiver configured to listen for an on signal or an off signal; and
a switch configured to allow current to flow between the electrical plug to the socket dependence upon the receiving an on signal and to prevent current from flowing in dependence upon receiving an off signal.

2. The system of claim 1 wherein the master unit and slave unit each have a pairing module configured to pair the master unit and slave unit for radio frequency communications.

3. The system of claim 1 wherein the master unit includes an opto-isolator including a phototransistor and a light emitting diode.

4. The system of claim 1 wherein the master unit includes a TRIAD.

5. The system of claim 1 wherein the master unit includes a solenoid.

6. A method of providing remote control for an always-hot receptacle through a switch for a switched receptacle, the method comprising:
listening, by a slave, for an on signal or an off signal;
wherein the slave comprises a socket for providing current to an electrical appliance and a plug adapted to receive current from a hot receptacle of an electrical outlet and having a switch with an on position allowing current to pass from the hot receptacle through the plug of the slave to its socket and an off position preventing current from passing through the slave;
receiving, by a master, through a plug plugged into the switch-powered receptacle, current;
broadcasting, by a radio-frequency transmitter of the master, an on signal;
charging, by the master unit, power-down logic with the received current;
receiving, by a radio-frequency transmitter of a slave unit, the on signal indicating that the master unit is receiving current and switching by the slave the switch to the on position,
upon no longer receiving current, de-charging, by the master, the passive power-down logic including broadcasting, by a radio-frequency transmitter of the master, an off signal;
receiving the off signal and switching, by the slave, the switch to the off position.

7. The method of claim 6 further comprising pairing the master and the slave for data communications.

8. The method of claim 7 wherein pairing the master and the slave for data communications comprises broadcasting), by the master unit, a pairing signal.

9. The method of claim 7 wherein broadcasting an on signal further comprises periodically broadcasting an on signal when the master is receiving current.

10. The method of claim 7 wherein broadcasting an off signal further comprises iteratively broadcasting an off signal until the master powers down.

11. A method of providing remote control for an always-hot receptacle in dependence upon the state of a switch-powered receptacle, the method comprising:
receiving, by a slave unit from a master unit, a signal containing an on-off value in dependence upon whether power is currently being delivered to the master from a switched-controlled receptacle; and
delivering power, by the slave to slave-serviced appliances in dependence upon the on-off value.
